(19) United States
(12) Patent Application Publication
(10) Pub. No.: US 2015/0222325 A1
(43) Pub. Date: Aug. 6, 2015

(54) METHODS FOR TRANSMITTING AND RECEIVING DATA IN A DIGITAL TELECOMMUNICATIONS SYSTEM

(71) Applicant: SIGFOX, LABEGE (FR)

(72) Inventors: Laurence Sellier, Toulouse (FR); Christophe Fourtet, Pompignan (FR)

(21) Appl. No.: 14/425,007

(22) PCT Filed: Sep. 3, 2013
(86) PCT No.: PCT/FR2013/052029

§ 371 Date: Feb. 28, 2015

(30) Foreign Application Priority Data
Sep. 4, 2012 (FR) 1258213

(51) Int. Cl. H04B 1/7143; H04W 72/04

(52) U.S. Cl. CPC H04B 1/7143; H04W 72/0453; H04B 2201/71376; H04W 84/18

(57) ABSTRACT

A method for transmitting data via a terminal to a station of a digital telecommunications system. A first stream of data is encoded in data packets and a second stream of data is encoded in a frequency-hopping pattern. The data packets, in which the first stream of data is encoded, is consecutively transmitted in respective frequency bands of a frequency resource. The frequency bands are determined based on the frequency-hopping pattern in which the second stream of data is encoded.

### TECHNICAL FIELD

The present invention belongs to the field of digital telecommunications, and more particularly relates to a method for transmitting data from a terminal to a station of a digital telecommunications system, as well as a corresponding method for receiving data transmitted by said terminal.

### PRIOR ART

The present invention has a particularly advantageous, though in no way limiting application in narrowband telecommunications systems. The term “narrowband” is understood to mean that the instantaneous frequency spectrum of the radio signals transmitted by a terminal has a frequency width less than a kilohertz.

Such narrowband telecommunications systems are for example implemented in sensor networks, wherein sensors repeatedly send data representing measurements of a physical quantity to a data collection station. By non-limiting example, mention may be made of embedded sensors in electricity or gas meters, which transmit data related to electricity or gas consumption to a collection station for the purpose of establishing the billing associated with this consumption.

In a known manner, useful data are generally distinguished from control data. Useful data correspond for example to measurements of a physical quantity, whereas control data correspond to information allowing the interpretation of said useful data (identification code of the terminal having transmitted the useful data, transmission format used, quantity of useful data, etc.)

In the case of a sensor network, other types of useful data can be transmitted, such as for example data relating to the charge state of a storage battery of a sensor. Such useful data require a lower bit rate than that required for the physical quantity measurements, but must also be accompanied by control data. The transmission of this type of useful data leads to an inefficient use of the transmission channel since the ratio of the quantity of useful data to the quantity of control data is then low.

### DISCLOSURE OF THE INVENTION

The aim of the present invention is to remedy all or part of the limitations of the solutions of the prior art, notably those disclosed above, by proposing a solution which makes it possible to increase the maximum bit rate of data at constant frequency width of the instantaneous frequency spectrum of the radio signals transmitted by a terminal.

Furthermore, another aim of the present invention is to propose a solution which makes it possible to multiplex a first data stream and a second data stream requiring a lower bit rate than that required by the first data stream, without said first and second data streams disturbing each other, and preferably without increasing the quantity of control data to be transmitted.

Furthermore, another aim of the present invention is to propose a solution making it possible to transmit data from the second data stream “on the fly”, without having to previously inform the station of the presence or otherwise of said second data stream.

For this purpose, and according to a first aspect, the invention relates to a method for transmitting data by a terminal to a station of a digital telecommunications system, in which a first data stream is encoded in data packets and a second data stream is encoded in a frequency-hopping pattern, said data packets, in which the first data stream is encoded, being consecutively transmitted in respective frequency bands of a frequency resource, said frequency bands being determined according to said frequency-hopping pattern in which the second data stream is encoded.

Thus, the first data stream is transmitted in a conventional manner, in the form of data packets, which are transmitted in frequency bands chosen according to the second data stream. It will therefore be understood that the frequency width of the instantaneous frequency spectrum of the radio signals transmitted by the terminal, determined by the data packets, is unchanged whereas the maximum bit rate is increased by the simultaneous transmission of the second data stream encoded in the frequency-hopping pattern used. The maximum bit rate of the second data stream is in theory lower than that of the first data stream, since one symbol of the second data stream at the most can be transmitted simultaneously with a data packet, whereas each data packet will generally include several symbols from the first data stream.

The transmission of the second data stream being closely linked to the transmission of the first data stream, it is possible to transmit control data common to the two data streams only once. For example, an identification code of the terminal transmitting the first data stream and the second data stream is incorporated into each data packet in which the first data stream is encoded.

This increase in the maximum bit rate at constant frequency width of the instantaneous frequency spectrum is obtained at the expense of the processing to be carried out by the station, inasmuch as the latter no longer has a priori knowledge of the frequency-hopping pattern used by the terminal for transmitting the data packets. The station must therefore search the frequency resource to find the frequency bands in which the terminal has transmitted the data packets, before extracting both the first data stream and the second data stream.

Due to the fact that the station has to search by default for the frequency bands in which the terminal has transmitted the data packets, it is not necessary to inform said station of the presence or otherwise of data from the second data stream.

In particular modes of implementation, the transmission method can furthermore include one or more of the following features, taken separately or in all technically possible combinations.

In a particular mode of implementation, a theoretical frequency-hopping pattern being previously associated with the terminal, the second data stream is encoded in the form of a modification of said theoretical frequency-hopping pattern.

Such measures, according to which the second data stream is encoded in the frequency-hopping pattern used in relation to a theoretical frequency-hopping pattern, make it possible to benefit from the advantages of frequency-hopping, particularly in terms of frequency diversity, even when no data from the second data stream is transmitted. Indeed, the station, which knows or knows how to determine the theoretical frequency-hopping pattern previously associated with the terminal, can determine whether or not the data from the second data stream have been transmitted by comparison with the frequency-hopping pattern actually used by the terminal and, where applicable, extract the second data stream.

In a particular mode of implementation, the modification of the theoretical frequency-hopping pattern, to encode the second data stream, comprises the modification or the removal of at least one theoretical frequency hop from said theoretical frequency-hopping pattern.

In a particular mode of implementation, only theoretical frequency hops corresponding to predefined indices of the theoretical frequency-hopping pattern are modified or removed to encode the second data stream.

In a particular mode of implementation, the modification of the frequency hops can give sets of frequencies separated by particularly short hops, in the order of a few thousandths of ppm (parts per million) to a few tenths of ppm, or a few hertz to a few hundred hertz. The frequency trend can thus be compared to a quasi-continuous trend. In this case, the processing to extract the information encoded in the second data stream can be similar to “shape recognition” processing, consisting in analyzing the frequency trend which is thus quasi-analog.

According to a second aspect, the invention relates to a terminal of a digital telecommunications system including means configured to transmit data to a station in accordance with a transmission method according to the invention.

According to a third aspect, the invention relates to a method for receiving, by a digital telecommunications system, data transmitted in accordance with the invention by a terminal, said reception method including steps of:
searching, in the frequency resource, for data packets transmitted by the terminal,
extracting the first data stream from the detected data packets,
measuring the frequency bands in which the data packets have been detected,
extracting the second data stream according to the measurements of the frequency bands in which data packets have been detected.

As indicated previously, the station must search for the frequency bands in which the terminal has transmitted data packets, measure the frequency bands in which the data packets have been detected and thus estimate the frequency-hopping pattern used by the terminal.

Such a search for data packets in a frequency resource is already carried out in certain digital telecommunications systems. This is for example the case in the digital telecommunications system described in the international application WO 2011/154466, in which the frequency drift of the frequency synthesizing means of the terminal is greater than the frequency width of the instantaneous frequency spectrum of the radio signals transmitted by said terminals.

Such a search for data packets in a frequency resource is advantageously suited to a radio architecture of “software radio” type (called “Software Defined Radio” or SDR in the literature).

In particular modes of implementation, the reception method can furthermore include one or more of the following features, taken separately or in all technically possible combinations.

In a particular mode of implementation, the step of extracting the second data stream includes the comparison of the measurements of the frequency bands in which data packets have been detected to a theoretical frequency-hopping pattern associated with said terminal.

In a particular mode of implementation, the data packets incorporating a counter incremented by the terminal on each new transmission, the second data stream is furthermore extracted according to the counters of said data packets.

Such measures notably make it possible to determine, at station level, if packets of data have been lost, and therefore to improve the extraction of the second data stream by taking account of the lost data packets, where applicable.

Alternatively or additionally, the data packets can include a part encrypted by means of a rolling key incremented by the terminal on each new transmission, the second data stream being then furthermore extracted according to the rolling keys used for encrypting said data packets.

According to a fourth aspect, the invention relates to a station of a digital telecommunications system including means configured to receive data from a terminal in accordance with a reception method according to the invention.

### PRESENTATION OF THE FIGURES

The invention will be better understood upon reading the following description, given by non-limiting example, and made with reference to the figures, which represent:

FIG. 1: a schematic representation of a digital telecommunications system,

FIG. 2: a diagram illustrating the main steps of an exemplary implementation of a data transmission method.

FIG. 3: a diagram illustrating the main steps of an exemplary implementation of a data reception method.

In these figures, references that remain identical from one figure to another denote identical or analogous elements. For the sake of clarity, the elements represented are not to scale, unless specified otherwise.

### DETAILED DESCRIPTION OF EMBODIMENTS

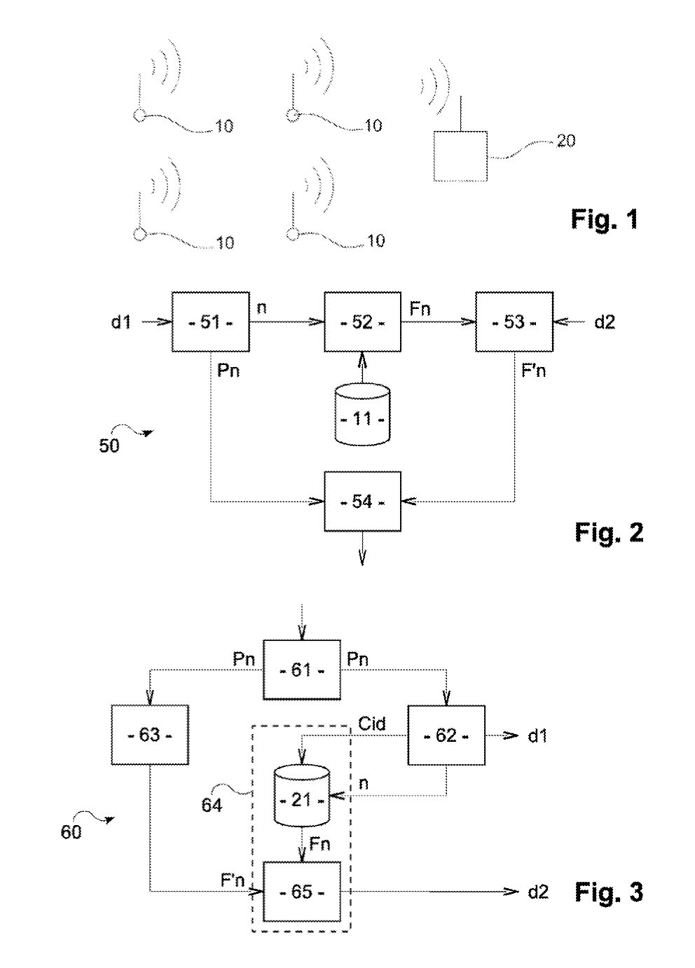

FIG. 1 represents a digital telecommunications system comprising several terminals 10 and a station 20

In the context of the invention, the term “station” is generally understood to mean any receiving device suitable for receiving data packets in the form of radio signals. The station 20 is for example any one of the terminals 10, or a particular device such as an access point to a wired or wireless telecommunications network.

The term “radio signal” is understood to mean an electromagnetic wave propagating via wireless means, the frequencies of which lie within the traditional radio wave spectrum (a few hertz to several hundreds of gigahertz), or in neighboring frequency bands.

The present invention first relates to a method 50 for transmitting data by a terminal 10 to the station 20.

In general, a transmission method 50 according to the invention allows the simultaneous transmission of two data streams.

A first data stream is encoded in the form of data packets. The data packets are formed in a conventional manner, for example by executing consecutive steps of channel encoding (by means of an error-correcting code such as a repetition code, a convolutional code, a turbocode etc.) and modulation (so as to obtain symbols such as BPSK, DBPSK, QPSK, 16 QAM, etc.)

Once formed, each data packet is frequency-translated to be transmitted in the form of a radio signal in a frequency band of a frequency resource, called “multiplexing band”, shared between the terminals 10.

Each frequency band is for example defined by the center frequency around which a data packet is translated, the frequency width AB of the instantaneous frequency spectrum of the corresponding radio signal being determined by the transmitted data packet.

A second data stream is encoded in the form of a frequency-hopping pattern used by the terminal 10 to choose the frequency bands in which it transmits the data packets formed from the first data stream. Thus, the frequency-hopping pattern, formed from the second data stream, determines the sequence of the consecutive central frequencies of the frequency bands in which the data packets of the first data stream are consecutively transmitted.

It should be noted that the first data stream and the second data stream can be of any type, useful data and/or control data.

Many combinations are possible. According to an example, the second data stream is composed of control data associated with useful data from the first data stream. According to another example, the second data stream includes useful data uncorrelated with the useful data from the first data stream. According to another example, the second data stream includes useful data correlated with the useful data from the first data stream, for example a copy of part of the useful data from the first data stream also transmitted in the second data stream for redundancy purposes etc.

In the case where the first data stream and the second data stream both include useful data, the control data common to said first and second data streams, such as for example an identification code of the terminal 10 which transmits them, are preferably transmitted in only one of said first and second data streams. In the case where an identification code of the terminal 10 is transmitted, it is for example included solely in the first data stream, and is consequently encoded solely in the data packets.

Each terminal 10 of the digital telecommunications system includes a set of software and/or hardware means configured to transmit data, to the station 20, in accordance with a transmission method 50 the general principle of which has been described above.

In a preferred embodiment, said means, configured to transmit data in accordance with a transmission method 50, the general principle of which has been described above, take the form of a digital transmission module and an analog transmission module.

The digital transmission module is suitable for forming the data packets from the first data stream and for forming a frequency-hopping pattern from the second data stream. It includes, for example, a processor and an electronic memory in which a computer program product is stored, in the form of a set of program code instructions which, when executed by the processor, implement all or part of the steps of forming the data packets and forming the theoretical frequency-hopping pattern. In a variant, the digital transmission module includes programmable logic circuits, of FPGA, PLD etc. type, and/or application-specific integrated circuits (ASIC), suitable for implementing all or part of said steps of forming the data packets and forming the frequency-hopping pattern.

The digital transmission module also includes one or more digital-analog (D/A) converters suitable for forming one or more analog signals from the data packets.

The analog transmission module is suitable for forming the transmitted radio signals, from said analog signals received from the digital transmission module. In particular, each analog transmission module frequency-translates the analog signals so that the latter are transmitted in the multiplexing band, in the frequency bands provided for by the frequency-hopping pattern formed from the second data stream. It should be noted that part of said frequency translations can be carried out by the digital transmission module, in baseband and/or on intermediate frequency, the final translation in the multiplexing band being carried out by the analog transmission module. In a variant, the analog transmission module can carry out all the frequency translations according to control signals, representative of the frequency-hopping pattern, received from the digital transmission module.

The analog transmission module can take any suitable conventional form, and for this purpose includes a set of means considered as known to those skilled in the art (antennas, analog filters, amplifiers, local oscillators, mixers etc.)

FIG. 2 represents a preferred mode of implementation of a transmission method 50, the general principle of which has been described previously, for transmitting a first data stream d1 and a second data stream d2.

In the example illustrated by FIG. 2, the non-limiting case is considered in which a theoretical frequency-hopping pattern has been previously associated with the terminal 10.

This is for example the case if the terminal 10 always uses the same frequency-hopping pattern to transmit the data packets, or if a frequency-hopping pattern has been previously negotiated with the station 20.

The theoretical frequency-hopping pattern is stored in an electronic memory 11 of the terminal 10, for example in the form of a sequence S={F1,F2, . . . FN} of N central frequencies Fn, 1≦n≦N to be used for the transmission of the data packets in the multiplexing band. Thus, if a data packet is transmitted around the center frequency F1, the following data packet is transmitted around the center frequency F2, the following data packet is transmitted around the center frequency F3, etc. If a data packet is transmitted around the center frequency FN, the following data packet is transmitted around the center frequency F1, etc.

It should be noted that other formats are possible for the theoretical frequency-hopping pattern, and that the choice of one particular format constitutes only a variant implementation of the invention. According to another non-limiting example, the theoretical frequency-hopping pattern can be stored in the memory in the form of a sequence S={ΔF1, ΔF2, . . . ΔFN} of N frequency hops ΔFn, 1≦n≦N to be used to change from one center frequency to the next.

As illustrated in FIG. 2, the transmission method 50 includes a step 51 of forming a data packet Pn, 1≦n≦N, from the first data stream d1.

The transmission method 50 furthermore includes a step 52 of determining, from the theoretical frequency-hopping pattern stored in the electronic memory 11, the theoretical frequency hop to be carried out to transmit said data packet Pn. For the index n of said data packet Pn, the theoretical frequency-hop consists in a frequency translation around the center frequency Fn.

In the particular mode of implementation illustrated in FIG. 2, the second data stream d2 is encoded in the form of a modification of said theoretical frequency-hopping pattern, during a step 53 of forming the frequency-hopping pattern to be used. More particularly, a modification δFn is computed according to said second data stream d2 so as to obtain a new center frequency F′n=Fn+δFn.

It should be noted that various processes can be applied to the second data stream d2. In particular, it is possible to apply channel encoding to it. Then, the modification δFn to be made is for example chosen from among several possible predefined modifications. The number M of possible predefined modifications δm (1≦m≦M) will determine the quantity of data from the second data stream d2 transmitted at each modification of the theoretical frequency-hopping pattern. For example, considering four possible predefined modifications δ1, δ2, δ3, δ4 and a second data stream d2 taking the form of a stream of binary data able to take the value 0 or 1, the choice of the modification δm to be applied can be made as indicated in the following table:

| Second data stream d2 | Modification |
|---|---|
| {00} | δ1 |
| {01} | δ2 |
| {10} | δ3 |
| {11} | δ4 |

It should be noted that, in particular modes of implementation, nothing excludes one of the modifications δm (1≦m≦M) being equal to zero. However, this requires the station 20 to know a priori that data from the second data stream d2 are transmitted. This is for example the case if data from the second data stream d2 are transmitted with each data packet Pn, or solely with data packets Pn of index n equal to a predefined value Np. If the station 20 does not know a priori when data from the second data stream d2 are transmitted, it is necessary to provide means for detecting the presence of such data in the second data stream d2, for example by considering only non-zero modifications δm (1≦m≦M). In such a case (δm modifications all non-zero), the detection of a modification of the center frequency Fn is equivalent to the detection of the presence of data from the second data stream d2.

The transmission method 50 then includes a step 54 of transmission of the data packet Pn, frequency-translated around the new center frequency F′n.

In the example illustrated in FIG. 2, each theoretical frequency hop is modified to transmit data from the second data stream.

According to other examples not illustrated by figures, nothing excludes the modifying of only part of the theoretical frequency-hopping pattern, for example modifying only theoretical frequency hops corresponding to predefined indices of the theoretical frequency-hopping pattern. For example, it is possible to modify only the theoretical frequency hops for the data packets Pn of which the index n is equal, modulo N, to a predefined value Np known to the station 20. Thus, the search by the station 20 for data packets in the multiplexing band is facilitated because, except for cases where the index n is equal, modulo N, to Np, the theoretical frequency-hopping pattern, known to the station 20, is not modified.

The present invention also relates to a data reception method 60 suitable for receiving the first data stream and the second data stream transmitted in accordance with a transmission method 50, the general principle of which has been described above.

The station 20 of the digital telecommunications system includes for this purpose a set of software and/or hardware means configured to receive data in accordance with a reception method 60, an exemplary implementation of which will be described below.

In a preferred embodiment, said means, configured to receive data transmitted by a terminal 10, appear in the form of an analog reception module and a digital reception module.

The analog reception module is suitable for receiving a global signal corresponding to all the radio signals received in the multiplexing band. For this purpose it includes a set of means, considered as known to those skilled in the art (antennas, analog filters, amplifiers, local oscillators, mixers etc.)

The analog reception module exhibits at the output an analog signal corresponding to the global signal brought to an intermediate frequency below the center frequency of the multiplexing band, said intermediate frequency can be zero.

The digital reception module includes, in a conventional manner, one or more analog/digital (A/D) converters suitable for sampling the analog signal or signals supplied by the analog reception module so as to obtain a digital signal.

The digital reception module furthermore includes a processor and an electronic memory in which a computer program product is stored, in the form of a set of program code instructions which, when they are executed by the processor, implement all or part of the steps of a method 60 for receiving data from the digital signal at the output of the ND converters. In a variant, the processing unit includes programmable logic circuits, of FPGA, PLD etc. type, and/or application-specific integrated circuits (ASIC), suitable for implementing all or part of the steps of said data reception method 60.

FIG. 3 represents a preferred mode of implementation of a method 60 for receiving data transmitted by the terminal 10, the main steps of which are as follows:
61 searching, in the multiplexing band, for data packets transmitted by the terminal 10,
62 extracting the first data stream d1 from the detected data packets,
63 measuring the frequency bands in which data packets have been detected,
64 extracting the second data stream d2 according to the measurements of the frequency bands in which data packets have been detected.

For example, the searching step 61 includes a computation of a frequency spectrum of the digital signal in the multiplexing band, and the search for local maxima in said frequency spectrum above a predefined detection threshold value.

In the example illustrated in FIG. 3, the data packet Pn is detected by the station 20, and the first data stream d1 is then extracted from said data packet Pn, in a conventional manner.

The purpose of step 63 of measuring the frequency bands in which data packets have been detected is to estimate the frequency-hopping pattern used by the terminal 10 for transmitting the data packets. It should be noted that, in the case of a search for local maxima of the frequency spectrum of the digital signal in the multiplexing band, the detection of a data packet and the measurement of the frequency band in which this data packet has been received are substantially simultaneous.

In the example illustrated in FIG. 3, the data packet Pn has been detected in the frequency band of center frequency F′n.

The second data stream d2 is then extracted, during step 64, according to the measurements of frequency bands in which data packets, i.e. according to the estimate of the frequency-hopping pattern used by the terminal 10.

As indicated previously, in the example illustrated by FIG. 3 the case is considered in which a theoretical frequency-hopping pattern is previously associated with the terminal 10 having transmitted the data packets. Said theoretical frequency-hopping pattern is for example previously stored in an electronic memory 21 of the station 20.

The station 20 being able to receive data packets from several terminals 10, said station 20 stores in the memory, for example, several theoretical frequency-hopping patterns respectively associated with the various terminals 10 of the digital telecommunications system.

Means are preferably provided for allowing said station 20 to identify the terminal 10 having transmitted the data packets. In a preferred mode of implementation, illustrated in FIG. 3, each terminal 10 incorporates a specific identification code into the data packets that it transmits. In this way, the reading by the station 20 of the identification code incorporated into a data packet allows it to retrieve from the electronic memory 21 the theoretical frequency-hopping pattern associated with the terminal 10 having transmitted this data packet.

It should be noted that other means, considered as within the scope of those skilled in the art, can be implemented to allow the station 20 to identify the terminal 10 having transmitted the data packets. According to another example, the instant of transmission of a data packet is previously negotiated by the terminal 10 with the station 20, so that the instant of reception of a data packet will be able to allow the station 20 to identify the terminal 10 having transmitted this data packet. According to another example, in the case of a digital telecommunications system with multiple access by code division (known as “Code Division Multiple Access” or CDMA in the English literature), the determination by the station 20 of the code used by a terminal 10 will make it possible to identify this terminal 10.

In the example illustrated by FIG. 3, an identification code Cid is extracted from the data packet Pn, which allows the station 20 to retrieve from the electronic memory 21 the theoretical frequency-hopping pattern associated with the terminal 10 having transmitted the data packet Pn.

In the particular mode of implementation illustrated by FIG. 2, furthermore and in a non-limiting manner, the case is considered in which each terminal 10 incorporates into a transmitted data packet a counter which is incremented by said terminal on each new transmission.

The extraction of the counter from the received data packet Pn allows the station 20 to determine the index n of said data packet, and thus to determine, from the theoretical frequency-hopping pattern, the theoretical frequency hop predicted for the data packet Pn, which consists in a frequency translation around the center frequency Fn.

The second data stream d2 is then extracted during a step 65 of comparing the frequency-hopping pattern estimated by the station 20 with the theoretical frequency-hopping pattern associated with the terminal 10, i.e. by comparing the measured frequency band F′n to the center frequency Fn predicted by the theoretical frequency-hopping pattern.

In the example described above with reference to FIG. 2, the station 20 for example evaluates the difference (F′n−Fn) and compares it to the possible predefined modifications δm (1≦m≦M). If the difference (F′n−Fn) is substantially equal to δ1 the station 20 considers that the binary data {00} have been transmitted, if the difference (F′n−Fn) is substantially equal to δ2 the station 20 considers that the binary data {01} have been transmitted, etc.

More generally, it should be noted that the modes of implementation and embodiments considered above have been described by non-limiting examples, and that other variants may consequently be envisaged.

In particular, the invention has been described considering that a theoretical frequency-hopping pattern was associated with each terminal 10. According to other examples, nothing excludes not considering any theoretical frequency-hopping pattern, the frequency-hopping pattern being then entirely determined by the second data stream. However, if data from the second data stream are not transmitted with each data packet from the first data stream, no frequency hop will be carried out in the absence of data from the second data stream. By considering a theoretical frequency-hopping pattern, a frequency hop is still carried out, making it possible to reduce the collisions, at the station 20 level, between data packets transmitted by the various terminals 10, but also to benefit from greater frequency diversity.

Furthermore, the invention has been described considering that the theoretical frequency-hopping pattern was modified by modifying one or more theoretical frequency hops. According to other examples, nothing excludes modifying the theoretical frequency-hopping pattern in another way, for example by removing certain theoretical frequency hops, i.e. by puncturing said theoretical frequency-hopping pattern.

Furthermore, an example has been described above in which the data packets incorporate a counter incremented by the terminal 10 at each new transmission. In practice, such an item of information makes it possible to determine the theoretical frequency hop predicted by the theoretical frequency-hopping pattern, and is especially necessary if data packets can be lost, i.e. transmitted by a terminal 10 and not received by the station 20.

Other means allowing the station 20 to determine the theoretical frequency hop predicted by the theoretical frequency-hopping pattern can be provided. According to a first non-limiting example, if part of the data packets is encrypted with a rolling key incremented by the terminal 10 at each new transmission, the station 20 can increment the rolling key that it uses to try to decrypt a data packet to obtain a rolling key that makes it possible to successfully decrypt said data packet. The increment required to successfully decrypt said data packet makes it possible to determine the theoretical frequency hop predicted by the theoretical frequency-hopping pattern. According to a second non-limiting example, if the data packets are transmitted by a terminal 10 with a predefined period, then the instants of reception of said data packets make it possible to determine the theoretical frequency hop predicted by the theoretical frequency-hopping pattern.

1-10. (canceled)

11. A method for transmitting data by a terminal to a station of a digital telecommunications system, comprising the steps of:
encoding a first data stream in data packets;
encoding a second data stream in a frequency-hopping pattern; and
consecutively transmitting the data packets, in which the first data stream is encoded, in respective frequency bands of a frequency resource, the frequency bands are determined according to the frequency-hopping pattern in which the second data stream is encoded.

12. The transmission method as claimed in claim 11, further comprising the steps of associating a theoretical frequency-hopping pattern with the terminal; and encoding the second data stream in a modification of the theoretical frequency-hopping pattern.

13. The transmission method as claimed in claim 12, further comprising the step of modifying or removing at least one theoretical frequency hop from the theoretical frequency-hopping pattern to encode the second data stream.

14. The transmission method as claimed in claim 13, further comprising the step of modifying or removing only theoretical frequency hops corresponding to predefined indices of the theoretical frequency-hopping pattern to encode the second data stream.

15. A method for receiving, by the station of a digital telecommunications system, data transmitted by the terminal in accordance with the transmission method as claimed in claim 11, comprising the steps of:
searching, in a frequency resource, for data packets transmitted by the terminal;
extracting the first data stream from the detected data packets;
measuring the frequency bands in which the data packets have been detected;
extracting the second data stream according to measurements of the frequency bands in which the data packets have been detected.

16. The reception method as claimed in claimed 15, further comprising the step of comparing the measurements of the frequency bands in which the data packets have been detected to a theoretical frequency-hopping pattern associated with the terminal.

17. The reception method as claimed in claim 15, wherein the data packets incorporate a counter incremented by the terminal on each new transmission; and further comprising the step of extracting the second data stream according to the counter of the data packets.

18. The reception method as claimed in claim 15, further comprising the steps of encrypting a part of the data packets with a rolling key incremented by the terminal at each new transmission; and extracting the second data stream according to the rolling keys used for encrypting the data packets.

19. A terminal of a digital telecommunications system comprises a transmitter configured to transmit data to a station, the transmitter:
encodes a first data stream in data packets;
encodes a second data stream in a frequency-hopping pattern; and
consecutively transmits the data packets, in which the first data stream is encoded, in respective frequency bands of a frequency resource, the frequency bands are determined according to the frequency-hopping pattern in which the second data stream is encoded.

20. A station of a digital telecommunications system comprises a receiver configured to receive data from the terminal of claim 19, the receiver:
searches, in a frequency resource, for the data packets transmitted by the terminal;
extracts the first data stream from the detected data packets;
measures frequency bands in which the data packets have been detected;
extracts the second data stream according to measurements of the frequency bands in which the data packets have been detected.
